(19) United States
(12) Patent Application Publication
(10) Pub. No.: US 2017/0045733 A1
(43) Pub. Date: Feb. 16, 2017

(54) DISPLAY APPARATUS HAVING A HIGHLY REFLECTIVE FRONT-FACING SURFACE

(71) Applicant: Pixtronix, Inc., San Diego, CA (US)

(72) Inventors: Xia Ren, Tempe, AZ (US); Jianru Shi, Haverhill, MA (US); Lu Lu, Woburn, MA (US)

(21) Appl. No.: 14/822,276

(22) Filed: Aug. 10, 2015

(51) Int. Cl. G02B 26/04; B60R 1/12; G06F 3/14; F21V 7/00

(52) U.S. Cl. CPC G02B 26/04; F21V 7/00; B60R 1/12; G06F 3/14; B60R 2001/1215

(57) ABSTRACT

This disclosure provides systems, methods, and apparatus for mirror displays. In one aspect, a mirror display can include a front transparent substrate, a rear transparent substrate, and a plurality of display elements between the front transparent substrate and the rear transparent substrate. A first light-blocking layer can be on a rear surface of the front transparent substrate. The first light blocking layer can have a reflectance of at least about 50%. A plurality of apertures can be formed through the first light-blocking layer. Each aperture can correspond to a respective one of the plurality of display elements. The total area of the apertures can account for less than about 50% of the area of the image-rendering region.

### TECHNICAL FIELD

This disclosure relates to the field of imaging displays, and to light modulators incorporated into imaging displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, or a combination of these or other micromachining processes that etch away parts of substrates, the deposited material layers, or both. Such processes may also be used to add layers to form electrical and electromechanical devices.

EMS-based display apparatus can include display elements that modulate light by selectively moving a light blocking component into and out of an optical path through an aperture defined through a light blocking layer. Display apparatus can be positioned behind mirrored surfaces, but may suffer from poor reflectance and poor display quality as a result.

### SUMMARY

The systems, methods and devices of this disclosure each have several innovative aspects, no single one of which is solely responsible for the desirable attributes disclosed herein.

One innovative aspect of the subject matter described in this disclosure can be implemented in a mirror display. The mirror display can include a first transparent substrate, a backlight on a first side of the first transparent substrate, and a second transparent substrate on a second side of the first transparent substrate. The mirror display can include a plurality of display elements within an image-rendering region between the first transparent substrate and the second transparent substrate. The mirror display can include a first light-blocking layer on a surface of the second transparent substrate nearest to the backlight. The first light-blocking layer can have a reflectance of at least about 50%. The mirror display can include a plurality of apertures formed through the light-blocking layer. Each aperture can correspond to a respective one of the plurality of display elements, and the total area of the apertures can account for less than about 50% of the area of the image-rendering region.

In some implementations, a surface of each display element farthest from the backlight can have a reflectance of at least about 50%. In some implementations, each display element can be configured to be in a closed position when the mirror display is powered off. In some implementations, the mirror display can include a controller configured to drive each display element into a closed position when the mirror display is powered off.

In some implementations, a surface of each display element farthest from the backlight can be light absorbing. In some implementations, the mirror display also can include a controller configured to drive each display element into an open position when the mirror display is powered off. In some implementations, the backlight can include a layer of reflective material configured to reflect light towards the second transparent substrate on a surface of the backlight farthest from the first transparent substrate.

In some implementations, the total area of the apertures can account for less than about 25% of the area of the image-rendering region. In some implementations, the first light-blocking layer can include a dielectric mirror. In some implementations, the mirror display can include a second light-blocking layer on a surface of the first transparent substrate on the second side of the first transparent substrate. The second light-blocking layer can be light absorbing.

In some implementations, at least one of a side mirror and a rear view mirror of an automobile can include the mirror display. In some implementations, a wall mirror can include the mirror display. In some implementations, the plurality of display elements can include microelectromechanical systems (MEMS) shutter-based display elements. In some implementations, the mirror display can include a second light-blocking layer on the surface of the second transparent substrate nearest to the backlight. The second light-blocking layer can be closer to the backlight than the first light-blocking layer.

In some implementations, the mirror display can include a processor capable of communicating with the mirror display. The processor can be capable of processing image data. The mirror display also can include a memory device capable of communicating with the processor. In some implementations, the mirror display can include a driver circuit capable of sending at least one signal to the mirror display and a controller capable of sending at least a portion of the image data to the driver circuit. In some implementations, the mirror display can include an image source module capable of sending the image data to the processor. The image source module can include at least one of a receiver, transceiver, and transmitter. The mirror display also can include an input device capable of receiving input data and communicating the input data to the processor.

Another innovative aspect of the subject matter described in this disclosure can be implemented in a mirror display. The mirror display can include a first transparent substrate, a light emitting means on a first side of the first transparent substrate, and a second transparent substrate on a second side of the first transparent substrate. The second side of the first transparent substrate can be opposite the first side of the first transparent substrate. The mirror display can include a plurality of light modulating means within an image-rendering region between the first transparent substrate and the second transparent substrate. The mirror display can include a light-blocking means on a surface of the second transparent substrate nearest to the light emitting means. The light-blocking means can have a reflectance of at least about 50%. The mirror display can include a plurality of apertures formed through the light-blocking means. Each aperture can correspond to a respective one of the plurality of light modulating means. The total area of the apertures can account for less than about 50% of the area of the image-rendering region.

In some implementations, a surface of the light modulating means farthest from the light emitting means can have a reflectance of at least about 50%. In some implementations, a surface of each light modulating means farthest from the light emitting means can be light absorbing. In some implementations, the total area of the apertures can account for less than about 25% of the area of the image-rendering region.

Another innovative aspect of the subject matter described in this disclosure can be implemented in an apparatus. The apparatus can include a mirror having an electrically active region including. The electrically active region can include a first transparent substrate, a backlight on a first side of the first transparent substrate, and a second transparent substrate on a second side of the first transparent substrate. The electrically active region can include a plurality of shutter-based display elements between the first transparent substrate and the second transparent substrate. The electrically active region can include a light-blocking layer on a surface of the second transparent substrate nearest to the backlight. The light-blocking layer can be substantially reflective. The electrically active region can include a plurality of apertures formed through the light-blocking layer. Each aperture can correspond to a respective one of the plurality of display elements. The total area of the apertures can account for less than about 50% of the area of the electrically active region. The electrically active region can include a controller capable of driving the plurality of display elements into respective open and closed positions corresponding to image data.

In some implementations, a surface of each display element farthest from the backlight has a reflectance of at least about 50%. In some implementations, each display element can be configured to be in a closed position when the mirror display is powered off. In some implementations, the controller can be configured to drive each display element into a closed position when the mirror display is powered off.

In some implementations, a surface of each display element farthest from the backlight can be light absorbing. In some implementations, the controller can be configured to drive each display element into an open position when the mirror display is powered off. In some implementations, the backlight can include a layer of reflective material configured to reflect light towards the second transparent substrate on a surface of the backlight farthest from the first transparent substrate. In some implementations, the total area of the apertures can account for less than about 25% of the area of the electrically active region. In some implementations, at least one of a side mirror and a rear view mirror of an automobile can include the apparatus.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3A shows a cross-sectional view of an example mirror display including a shutter-based light modulator in an open position.

FIG. 3B shows a cross-sectional view of the example mirror display shown in FIG. 3A with the shutter-based light modulator in a closed position.

FIG. 4A shows a cross-sectional view of an example mirror display including a shutter-based light modulator in an open position.

FIG. 4B shows a cross-sectional view of the example mirror display shown in FIG. 4A with the shutter-based light modulator in a closed position.

FIG. 5A shows an example rear view mirror incorporating a mirror display.

FIG. 5B shows an example side mirror incorporating a mirror display.

FIG. 5C shows an example wall mirror incorporating a mirror display.

FIG. 5D shows an enlarged top view of an example mirror display that can be used as the mirror displays shown in FIGS. 5A-5C.

FIGS. 6A and 6B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Display devices can be incorporated into mirrored surfaces for various applications. For example, a rear view mirror or side mirror of a vehicle can include a display device configured to provide a driver with relevant information, such as the vehicle's speed, direction of travel or proximity to objects, among other information. Display devices also can be incorporated into mirrors in interior settings, such as wall mirrors. Thus, a portion of a mirrored surface can be used as an image-rendering region (sometimes also referred to as an electrically active region), while the rest of the surface remains reflective. In general, it can be desirable for the entire surface, including the image-rendering region, to be reflective when the mirror display is powered off. Such a mirror display can be achieved using a front reflective layer with a plurality of apertures positioned within the image-rendering region of the display.

The apertures in the front reflective layer can correspond to display elements positioned behind the front reflective layer, and can provide an optical path through each display element to allow for the formation of images on the mirror display. The total area of the apertures can be significantly less than the total area of the image-rendering region. For example, the image forming region may have an aperture ratio of less than about 20%. As a result, a large percentage of the image-rendering region can include the reflective material that forms the front reflective layer, and the image-rendering region can therefore be highly reflective when the mirror display is powered off. In some implementations, the front reflective layer can be positioned behind a front transparent substrate that forms a cover plate for the mirror display.

In some implementations, the display elements can be shutter-based light modulators. The shutter-based light modulators can be positioned between the front transparent substrate and a rear transparent substrate. A backlight can be positioned behind the rear transparent substrate. The shutters of the display elements can form images by moving into and out of the optical paths corresponding to their respective apertures in the front reflective layer. In some implementations, to enhance the reflectance of the image-rendering region when the mirror display is powered off, the front-facing surfaces of the shutters can be formed from a highly reflective material. When the mirror display is powered off, all of the shutters can be driven into their respective closed positions. Ambient light directed towards the front apertures from the front side of the mirror display can be reflected back by the front-facing surfaces of the shutters. Thus, effectively the entire surface area of the image-rendering region can be made reflective when the mirror display is powered off.

In some other implementations, the front-facing surfaces of the shutters can instead be formed from a light absorbing material. A front-facing optical surface of the backlight can be formed from a reflective material. When the mirror display is powered off, the shutters can be driven into their respective open positions. Ambient light directed towards the front apertures from the front side of the mirror display can therefore be reflected back towards the front of the mirror display by the front-facing surface of the backlight.

In some implementations, the mirror display can include additional light blocking layers. For example, the mirror display can include a light absorbing layer on a rear-facing surface of the front reflective layer. Another light absorbing layer can be positioned on a front-facing surface of the rear substrate. The light absorbing layers can improve the light management capabilities of the mirror display by absorbing stray light that may reflect off of surfaces of the shutters. In some implementations, the mirror display also can include a circuit layer having circuitry for controlling the display elements. The circuit layer can be formed over either the front substrate or the rear substrate. For example, in implementations in which the display elements are formed over the front substrate (sometimes referred to as a MEMS-down configuration), the circuit layer also can be formed over the front substrate. Similarly, in implementations in which the display elements are formed over the rear substrate (sometimes referred to as a MEMS-up configuration), the circuit layer also can be formed over the rear substrate.

Particular implementations of the subject matter described in this disclosure can be implemented to realize one or more of the following potential advantages. A mirror display with a front reflective layer having a plurality of apertures can help to increase the reflectance of an image-rendering region of the mirror display. For example, typical mirror displays are formed by positioning an electronic display device behind a partially reflective surface. The partially reflective surface is configured to reflect some portion of ambient light, but also to allow for the transmission of light from the display device that is positioned behind the partially reflective surface. Because higher reflectance generally necessitates lower transmittance, such a partially reflective surface cannot be configured to be both highly reflective and to allow a high degree of light transmission. As a result, a mirror display incorporating a partially reflective surface positioned in front of a display device can suffer from poor reflectance as well as poor display quality. In contrast, an apertured front reflective layer can be formed from a highly reflective material, because there is no need for the material itself to transmit light from the display device. Instead, the apertures formed in the reflective layer serve as a means for light transmission. By selecting a relatively small aperture ratio, a mirror display including an apertured front reflective layer can have a high reflectance as well as improved image quality relative to conventional mirror displays.

Incorporating shutters having reflective front-facing surfaces can further improve the reflectance of the mirror display when the mirror display is powered off. The shutters can be moved into their respective closed positions, in which each shutter obstructs its corresponding aperture. In this configuration, substantially the entire front-facing surface of the mirror display can be made highly reflective. In some other implementations, a backlight of the mirror display can have a front-facing surface formed from a highly reflective material. The shutters can be moved into their respective open positions when the mirror display is powered off. Reflectance of the mirror display is therefore enhanced when the mirror display is powered off, because ambient light passing through the apertures of the front reflective layer can be reflected back towards the front of the mirror display by the front-facing reflective surface of the backlight. Because the shutters do not serve to enhance the reflectance of the mirror display in these implementations, the front-facing surfaces of the shutters can be made from a light absorbing material, which can improve the contrast ratio of the mirror display.

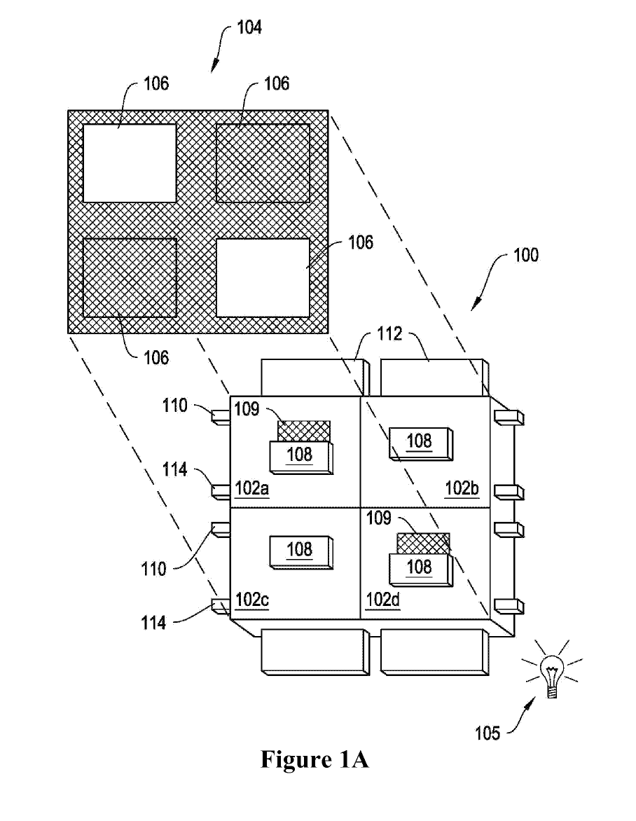

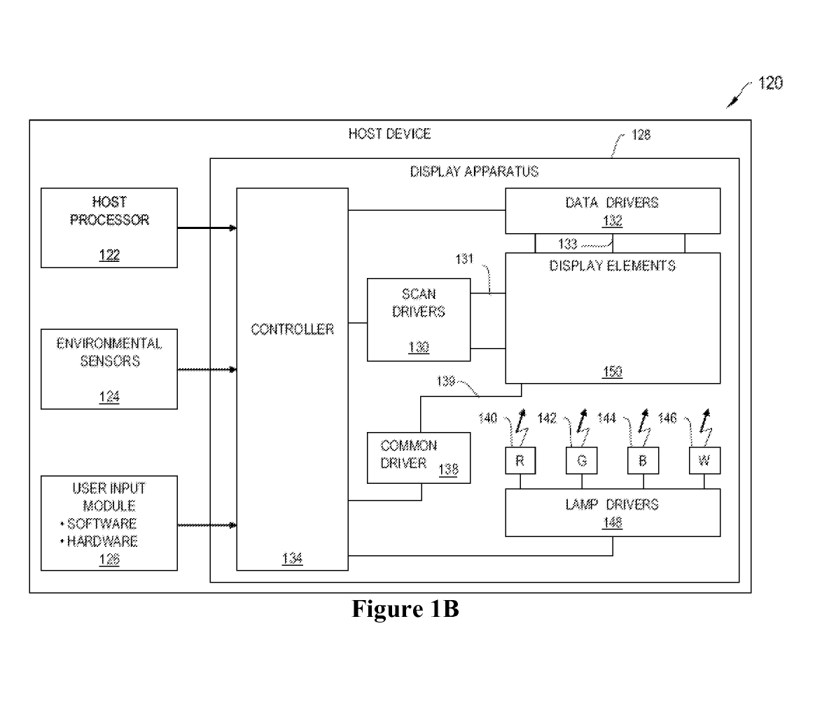

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness of the display, the contrast of the display, or both.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; instructions for the display apparatus 128 for use in selecting an imaging mode; or any combination of these types of information.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

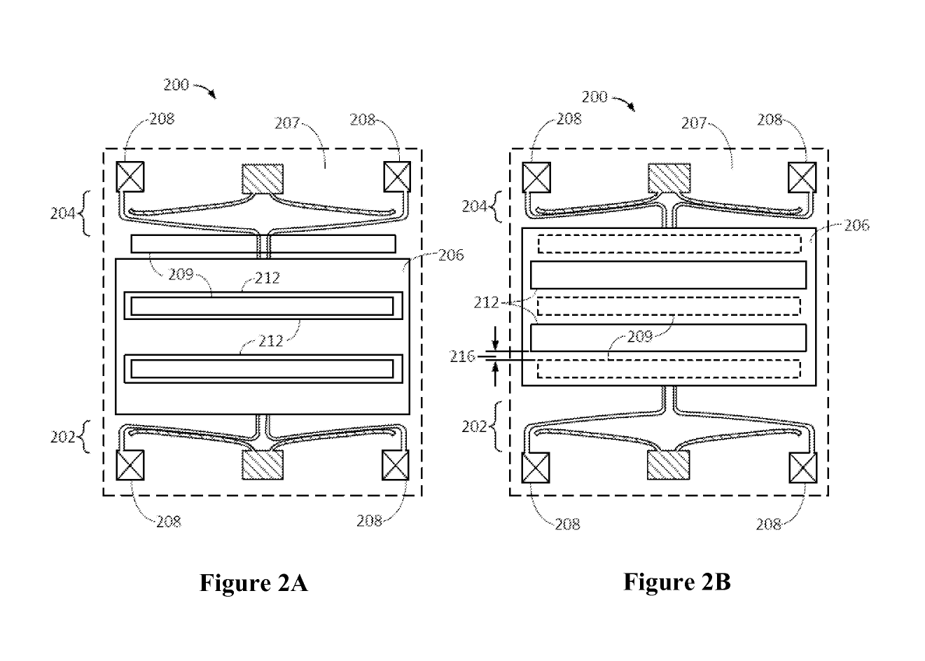

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage V.

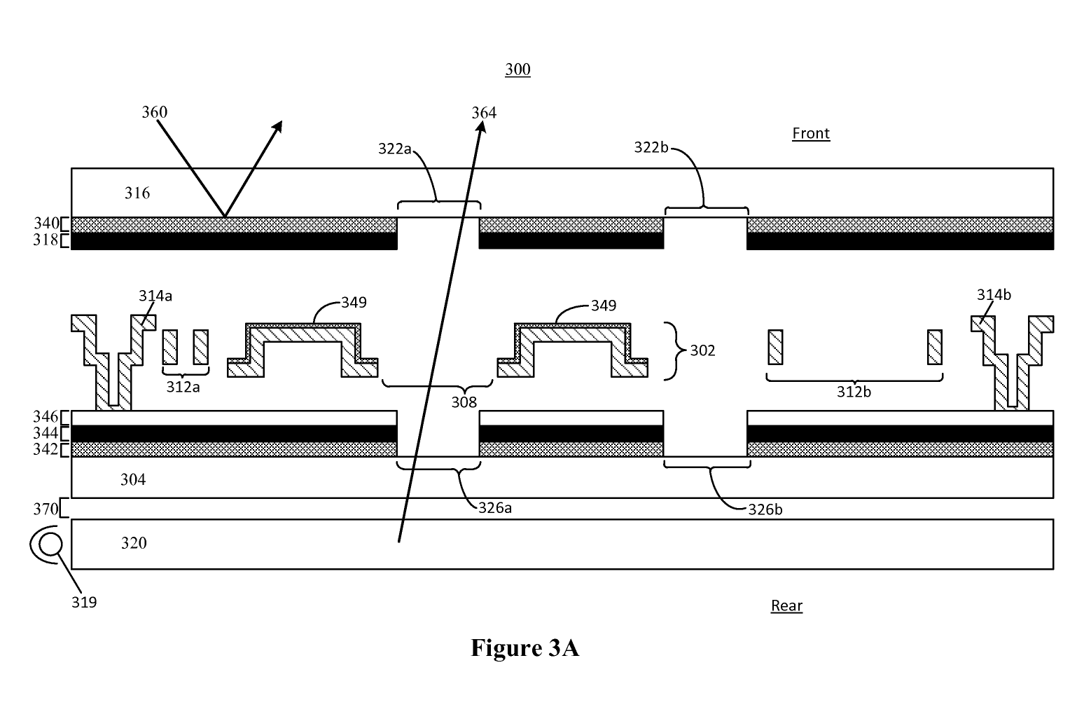

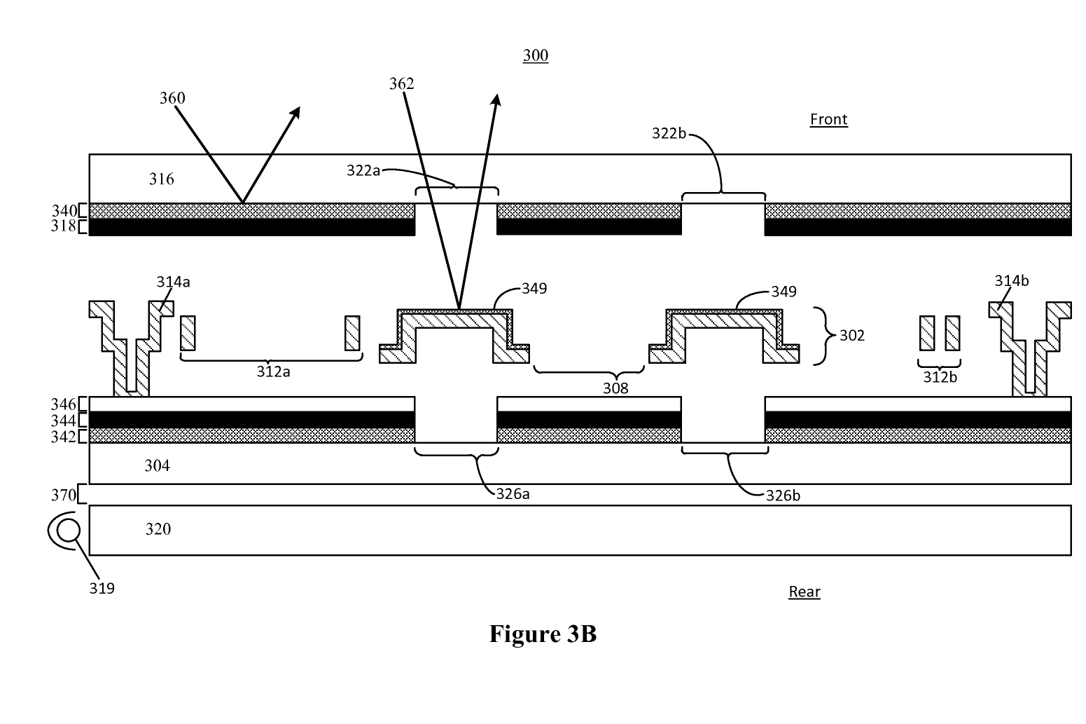

FIG. 3A shows a cross-sectional view of an example mirror display 300 including a shutter-based light modulator in an open position. FIG. 3B shows a cross-sectional view of the example mirror display 300 shown in FIG. 3A with the shutter-based light modulator in a closed position. Referring to FIGS. 3A and 3B, a shutter 302 is suspended between a front (or first) substrate 316 and a rear (or second) substrate 304. The shutter 302 includes a shutter aperture 308. The shutter 302 can be similar to the shutter 206 shown in FIGS. 2A and 2B, except that the shutter 302 includes one shutter aperture 308, rather than two shutter apertures. A shutter open actuator 312a and a shutter close actuator 312b (generally referred to as actuators 312) are positioned on the left and right sides of the shutter 302, respectively. The actuators 312 are capable of moving the shutter 302 laterally into open and closed positions, in response to actuation voltages. The shutter 302 is fabricated in what is referred to as a “MEMS-up” configuration, in which anchors 314a and 314b (generally referred to as anchors 314) are coupled to the rear substrate 304 and support the actuators 312 and the shutter 302 over the rear substrate 304.

The front substrate 316 includes two light obstructing layers on its rear-facing surface. The first light obstructing layer is a front reflective layer 340, which couples to the front substrate 316. The second light obstructing layer is a light absorbing layer 318 that couples to a rear-facing surface of the front reflective layer 340. The front reflective layer 340 and the light absorbing layer 318 define two front apertures 322a and 322b (generally referred to as front apertures 322). The rear substrate 304 includes a rear reflective layer 342 coupled to a front-facing surface of the rear substrate 304, a light absorbing layer 344 coupled to a front-facing surface of the rear reflective layer 342, and a circuit layer 346 coupled to a front-facing surface of the light absorbing layer 344. The rear reflective layer 342, the light absorbing layer 344, and the circuit layer 346 define two rear apertures 326a and 326b (generally referred to as rear apertures 326). In particular, the thicknesses of the front reflective layer 340, the light absorbing layer 318, the rear reflective layer 342, the light absorbing layer 344, and the circuit layer 346 are exaggerated for illustrative purposes. In practice, these layers can be much thinner than they appear in FIGS. 3A and 3B. In some implementations, the front substrate 316 of the mirror display 300 may include only a single light obstructing layer on its rear-facing surface. For example, the rear surface of the front substrate 316 may include only the front reflective layer 340, and may not include the light absorbing layer 318.

When the shutter 302 is in an open position, as shown in FIG. 3A, the front aperture 322a and the rear aperture 326a are aligned with the shutter aperture 308, while the optical path between the front aperture 322b and rear aperture 326b is also unobstructed by the shutter 302. A backlight formed by a light source 319 and a lightguide 320 is positioned behind the rear substrate 304. In some implementations, the lightguide 320 is separated from the rear substrate 304 by a gap 370. Thus, in the open position shown in FIG. 3A, the shutter 302 can allow the light from the lightguide 320 passing through the rear apertures 326 to continue to pass towards the front substrate 316 and out of the mirror display 300 through the front apertures 322, as shown by the light ray 364. The shutter 302 can be moved into the open position by applying a voltage across a pair of electrode beams that form the shutter open actuator 312a. In some implementations, circuit elements, such as transistors, that are used for generating or transmitting actuation voltages can be included within the circuit layer 346. Actuation voltages can be transmitted from the circuit layer 346 to the actuators 312 through the anchors 314, which are formed over the circuit layer 346. In some implementations, the circuit layer 346 can include circuit elements formed from transparent conductive materials, such as indium tin oxide (ITO), so that light impinging on the surface of the circuit layer 346 can pass through the circuit layer 346 and be absorbed by the light absorbing layer 344 positioned behind the circuit layer 346. In some other implementations, the circuit layer 346 can include circuit elements formed from materials having light-absorbing properties.

Light originating outside the mirror display 300 and directed towards the front side of the mirror display 300 can be reflected by the front reflective layer 340, as shown by the light ray 360. The front reflective layer 340 can be formed from any material that is substantially reflective. For example, the front reflective layer 340 can include one or more metal layers which can reflect substantially all light. For example, in some implementations, the front reflective layer 340 can include a reflective metal such as aluminum (Al), titanium (Ti), or silver (Ag). Alternatively, the front reflective layer 340 can include one or more dielectric materials, such as a dielectric mirror, which can reflect light impinging on its surface. For example, layers of dielectric materials having different indices of refraction (alternating between high indices of refraction and low indices of refraction), such as silicon oxide (SiOₓ) or silicon nitride (SiNₓ), can be included in a dielectric mirror. In some implementations, the front reflective layer 340 can include a combination of dielectric materials and conductive metals, such as a dielectrically enhanced mirror. In some implementations, the reflectance of the front reflective layer 340 can be at least about 50%, at least about 60%, at least about 70%, at least about 80%, at least about 90%, or higher. In some other implementations, the front reflective layer 340 can be replaced with a layer of material having lower reflectance, such as a layer of material having of reflectance of between about 40% and about 50%.

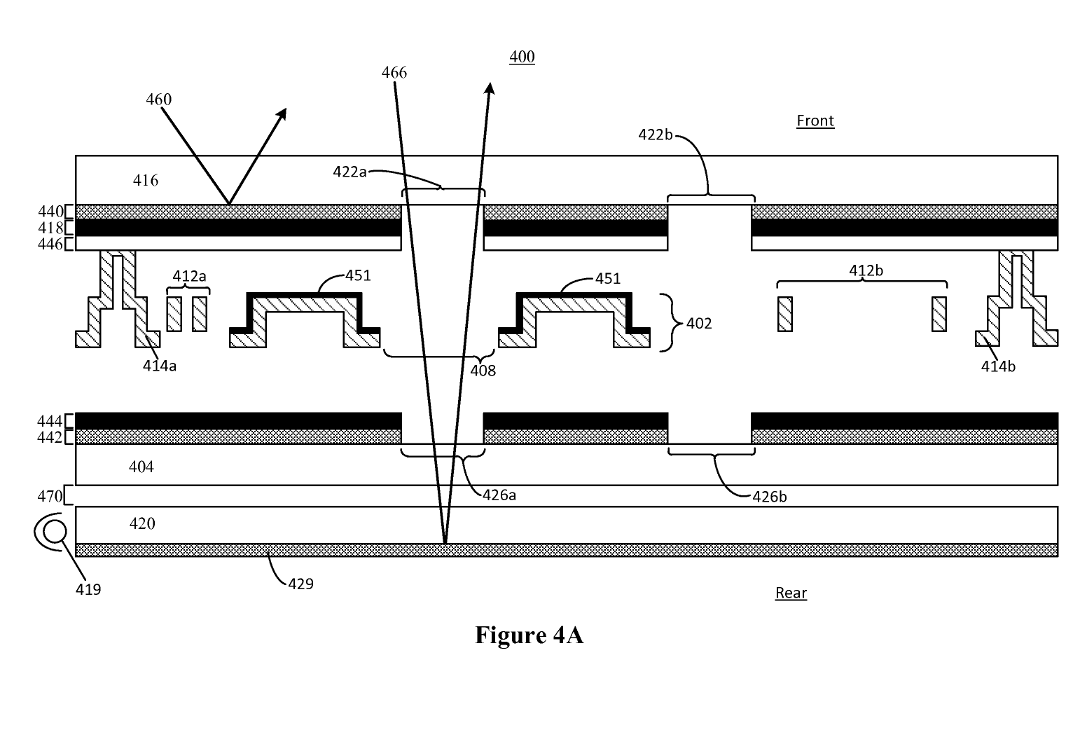

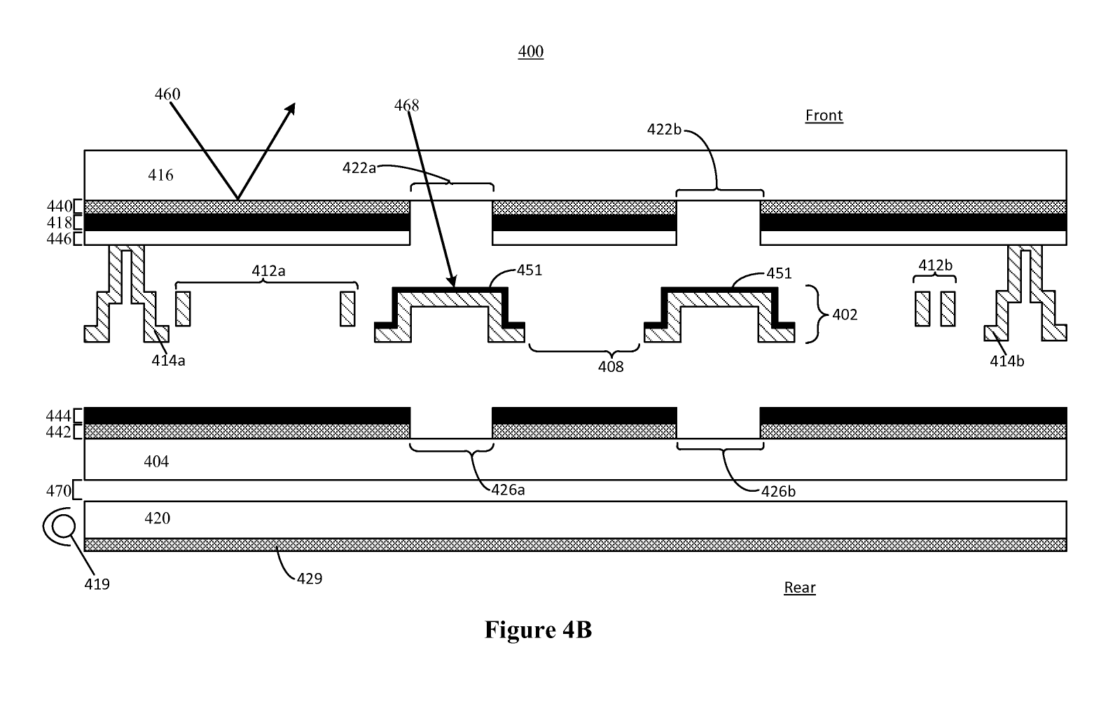

In implementations in which the circuit layer 346 is positioned on the rear substrate 304, as shown in FIGS. 3A and 3B, the reflective layer 340 can include conductive metal without substantially interfering with the operation of circuitry included within the circuit layer 346. For example, because the reflective layer 340 is formed on a different substrate from the circuit layer 346, the reflective layer 340 may not introduce meaningful levels of parasitic capacitance that could negatively impact the performance of circuitry in the circuit layer 346. In implementations in which a circuit layer is instead formed on a front substrate, it may be preferable for the front reflective layer 340 to be a dielectric mirror, avoiding the use of a metal which could introduce parasitic capacitance into the circuit layer 346. An example of such an implementation is shown in FIGS. 4A and 4B. In some other implementations in which a circuit layer is formed on a front substrate, the front reflective layer 340 can be formed from metal and the display also can include a layer of insulating material positioned between the front reflective layer 340 and the circuit layer. The layer of insulating material can help to reduce parasitic capacitance caused by the metal front reflective layer 340 that could negatively impact the performance of circuitry in the circuit layer.

The front reflective layer 340 can allow the mirror display 300 to be used as a mirror when the display elements are not being used to form images. As a result, the mirror display 300 can be useful for incorporation into a mirror, such as a rear view mirror or side mirror of an automobile, or a wall mirror or other mirror in an interior setting. To further improve the reflectance of the mirror display 300, the front-facing surface of the shutter 302 can include a reflective layer 349. When the mirror display 300 is powered off or is otherwise not being used to produce images, the shutter 302 can be driven into the closed position shown in FIG. 3B. This configuration can allow ambient light directed through the front apertures 322 to be reflected back to the front of the mirror display 300, as illustrated by the light ray 362 shown in FIG. 3B. Thus, the front-facing surface of the mirror display 300 can appear substantially reflective. As a result, a larger mirror, including the mirror display 300, may maintain its substantially reflective surface area when the mirror display 300 is powered off.

In some implementations, the mirror display 300 can include a controller that is configured to drive all of the display elements into their respective closed position when the mirror display 300 is powered off or is otherwise not being used to produce images. For example, a controller similar to the controller 134 shown in FIG. 1B can be configured to drive the display elements into their respective closed positions when the mirror display 300 is not being used to produce images.

In some implementations, the reflective layer 349 can be formed as a coating applied to the front-facing surface of the structural material that forms the shutter 302, as shown in FIGS. 3A and 3B. The other structural material that forms the shutter 302 can be light-absorbing so that light contacting the rear surface of the shutter 302 is absorbed, which can improve the contrast ratio of the mirror display 300 by reducing the amount of stray light that is able to pass out of the mirror display 300. In some other implementations, the entire shutter 302 can be formed from a reflective material. The reflective material can be a reflective metal, a dielectric mirror, or a dielectrically enhanced mirror. In some implementations, the front-facing surface of the shutter 302 can have a reflectance of at least about 50% as a result of the reflective layer 349. In some implementations, the front-facing surface of the shutter 302 can have a reflectance of at least about 60%, at least about 70%, at least about 80%, or at least about 90%. In some other implementations, the reflective layer 349 can be replaced with a layer of material having lower reflectance, such as a layer of material having of reflectance of between about 40% and about 50%.

FIG. 4A shows a cross-sectional view of an example mirror display 400 including a shutter-based light modulator in an open position. FIG. 4B shows a cross-sectional view of the example mirror display 400 shown in FIG. 4A with the shutter-based light modulator in a closed position. The mirror display 400 includes many of the features described above in connection with the mirror display 300 shown in FIGS. 3A and 3B. For example, FIGS. 4A and 4B show a shutter 402 suspended between a front (or first) substrate 416 and a rear (or second) substrate 404. The shutter 402 includes a shutter aperture 408. The shutter 402 can be similar to the shutter 206 shown in FIGS. 2A and 2B, except that the shutter 302 includes one shutter aperture 308, rather than two shutter apertures. A shutter open actuator 412a and a shutter close actuator 412b (generally referred to as actuators 412) are positioned on the left and right sides of the shutter 402, respectively. The front substrate 416 includes a front reflective layer 440 and a light absorbing layer 418. The front reflective layer 440 and the light absorbing layer 418 define two front apertures 422a and 422b (generally referred to as front apertures 422). The rear substrate 404 includes a rear reflective layer 442 coupled to a front-facing surface of the rear substrate 404 and a light absorbing layer 444 coupled to a front-facing surface of the rear reflective layer 442. The rear reflective layer 442 and the light absorbing layer 444 define two rear apertures 426a and 426b (generally referred to as rear apertures 426). As discussed above in connection with the mirror display 300 shown in FIGS. 3A and 3B, the front substrate 416 of the mirror display 400 may include only a single light obstructing layer on its rear-facing surface. For example, the rear surface of the front substrate 416 may include only the front reflective layer 440, and may not include the light absorbing layer 418.

The mirror display 400 differs from the mirror display 300 shown in FIGS. 3A and 3B in that the mirror display 400 is formed in a “MEMS-down” configuration. That is, the circuit layer 446 is positioned over the rear-facing surface of the front substrate 416, and the anchors 414 couple to the circuit layer 446 to suspend the shutter 402 over the front substrate 416. The front-facing surface of the shutter 402 also includes a light absorbing layer 451. As compared to the reflective layer 349 on the front-facing surface of the shutter 302 shown in FIGS. 3A and 3B, the light absorbing layer 451 can result in an improved contrast ratio when the mirror display 400 is being used to form images. For example, it can be beneficial to reduce the amount of stray light passing out of the mirror display 400 through the front apertures 422. Stray light can include ambient light originating outside of the mirror display 400, as well as light emitted from the lightguide 420 via the light source 419 that is able to pass through the front apertures 422 when the shutter 402 is in a closed position. The light absorbing layer 451 can reduce this stray light by absorbing, rather than reflecting, light that is not intended to exit the mirror display 400 through the front apertures 422, as illustrated by the light ray 468 shown in FIG. 4B. In some implementations, the light absorbing layer 451 can include a coating applied to the front-facing surface of the structural material that forms the shutter 402, as shown in FIGS. 4A and 4B. In some other implementations, a front-most layer of the shutter 402, or even the entire shutter 402, can include a light absorbing material.

To improve the reflective properties of the mirror display 400 when the mirror display 400 is powered off or otherwise not being used to form images, the lightguide 420 includes a front-facing reflective surface 429. A controller, such as the controller 134 shown in FIG. 1B, can be configured to drive the display elements into their respective open positions when the mirror display 400 is powered off. This configuration can allow ambient light directed through the front apertures 422 to be reflected back to the front of the mirror display 400 by the front-facing reflective surface 429, as illustrated by the light ray 466 shown in FIG. 4A. Thus, substantially the entire front-facing surface of the mirror display 400 can appear reflective. As a result, the presence of the mirror display 400 within a larger mirror may not substantially decrease the reflective surface area of the mirror when the mirror display 400 is powered off.

It should be noted that, in some implementations, a mirror display may incorporate features of the mirror display 400 as well as features of the mirror display 300 shown in FIGS. 3A and 3B. For example, in some implementations, a mirror display can be fabricated in a MEMS-up configuration (as shown in FIGS. 3A and 3B) and can include shutters whose front-facing surfaces are light absorbing (as shown in FIGS. 4A and 4B). Similarly, in some implementations, a mirror display can be fabricated in a MEMS-down configuration (as shown in FIGS. 4A and 4B) and can include shutters whose front-facing surfaces are reflective (as shown in FIGS. 3A and 3B).

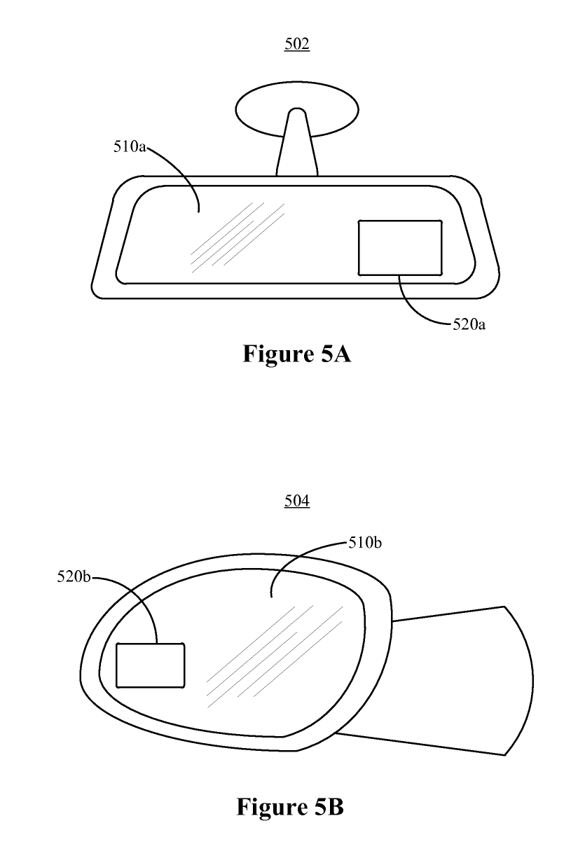

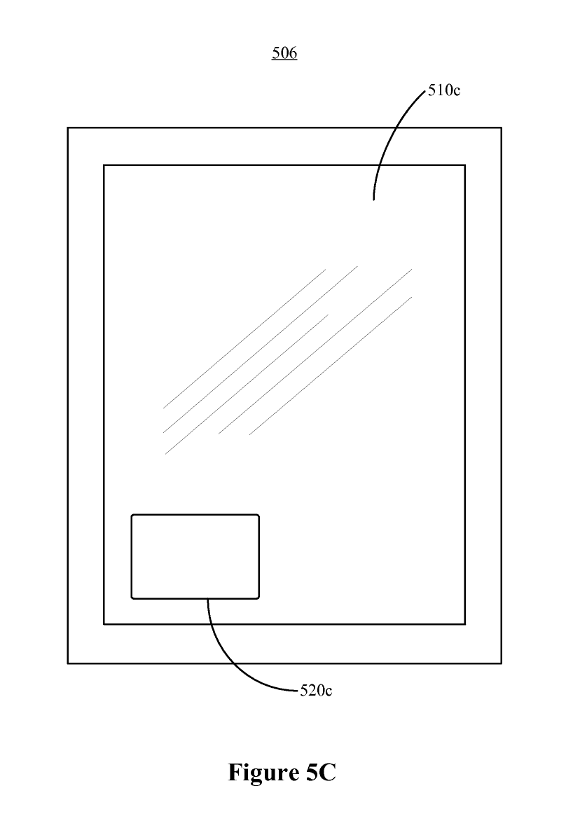

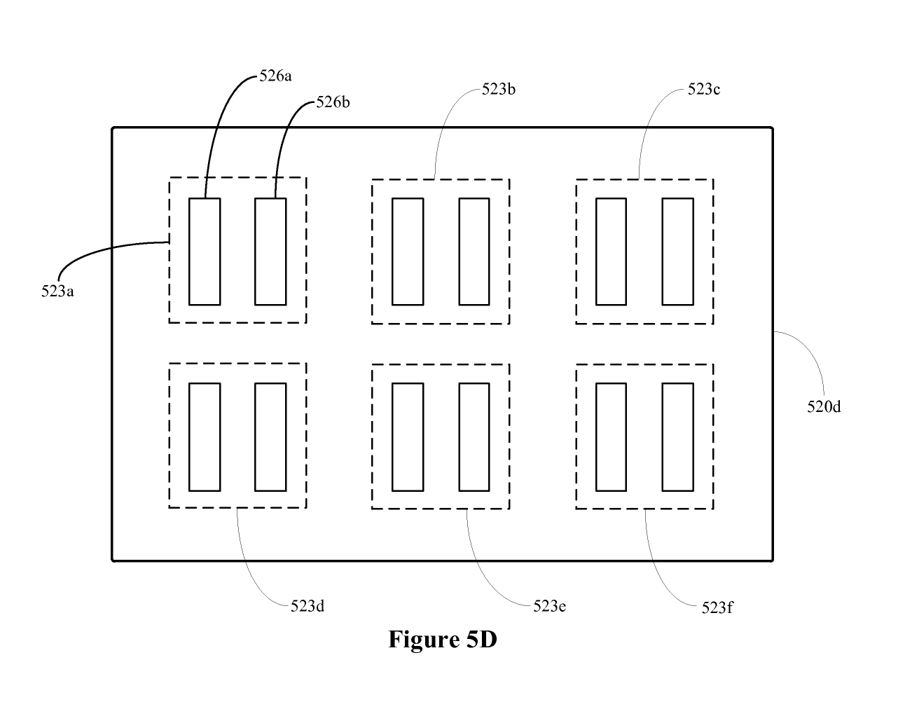

FIG. 5A shows an example rear view mirror 502 incorporating a mirror display 520a. The rear view mirror 502 includes a reflective surface 510a. In some implementations, the rear view mirror 502 can serve as a rear view mirror of an automobile or other vehicle. For example, the rear view mirror 502 can serve as a rear view mirror of a truck, a construction vehicle, a motorcycle, a recreational vehicle (RV), an autobus, a bicycle, a boat, or any other type of vehicle. The mirror display 520a is positioned within the reflective surface 510a. The portion of the reflective surface 510a allocated to the mirror display 520a can be referred to as an image-rendering region. Generally, safety can be improved in a vehicle having a rear view mirror with a relatively large reflective surface 510a, because the driver is able to see objects in a larger field of view behind the vehicle. Therefore, when the mirror display 520a is powered off, it can be beneficial for the image-rendering region to have reflective properties, so that the mirror display 520a does not detract from the reflective surface area of the rear view mirror 502 when the mirror display 520a is powered off.

To achieve this, the mirror display 520a can include a front reflective layer with a plurality of apertures corresponding to display elements positioned behind the front reflective layer, as discussed above in connection with FIGS. 3A, 3B, 4A, and 4B. In some implementations, shutters associated with the display elements can include reflective front-facing surfaces and can be driven into their respective closed positions when the mirror display 520a is powered off. Alternatively, a backlight of the mirror display 520a can include a front-facing reflective layer, and the shutters can be driven into their respective open positions to enhance the reflectance of the mirror display 520a when the mirror display 520a is powered off. When the mirror display 520a is powered on, the mirror display 520a can be used to display information to the driver of the vehicle. For example, the mirror display 520a can be used to display information corresponding to a current speed or direction of travel of the vehicle, video generated by a rear-facing camera mounted on the vehicle, directions to a destination of the vehicle, bus route information, information indicating the proximity of objects to the vehicle, nearest highway rest stops, or proximity to a no-wake zone in a body of water.

FIG. 5B shows an example side mirror 504 incorporating a mirror display 520b. The mirror display 520b is positioned within an image-rendering region of a reflective surface 510b of the side mirror 504. In some implementations, the side mirror 504 can serve as a rear view mirror of an automobile or other vehicle. For example, the side mirror 504 can serve as a rear view mirror of a truck, a construction vehicle, a motorcycle, a recreational vehicle (RV), an autobus, a bicycle, a boat, or any other type of vehicle.

FIG. 5C shows an example wall mirror 506 incorporating a mirror display 520c. The mirror display 520c is positioned within an image-rendering region of a reflective surface 510c of the wall mirror 506. The wall mirror 506 can be used in an interior setting. For example, the wall mirror 506 can be used in a bathroom or shopping mall dressing room. In some implementations, the wall mirror 506 can be positioned at the corner of a hallway in a building such as a hospital, to allow users to view people and objects approaching the corner. In some other implementations, the wall mirror 506 can be used on the exterior of a building. For reasons similar to those discussed above, it can be beneficial to form the mirror displays 520b and 520c such that their respective image-rendering regions remain reflective when the mirror displays 520b and 520c are powered off. In some other implementations, a mirror display similar to the mirror displays 520a, 520b, and 520c described above can be incorporated into any other form of mirror, including a shaving mirror, a vanity mirror, or a free-standing mirror having a suitable source of power (for example a battery) or AC power adapter and sufficient space for housing the associated components. For example, components housed within a mirror display can include a light guide, controller such as the controller 134 shown in FIG. 1B, memory, and drivers such as the scan drivers 130, data drivers 132, common driver 138, and lamp drivers 148 shown in FIG. 1B.

FIG. 5D shows an enlarged top view of an example mirror display 520d that can be used as the mirror displays 520a-520c shown in FIGS. 5A-5C, respectively. FIG. 5D shows six display elements 523a-523f (generally referred to as display elements 523). For illustrative purposes, six display elements 523 are shown; however, in practice, the mirror display 520d may include thousands or millions of display elements 523.

In the depicted implementation, each display element 523 includes a respective pair of front apertures, such as the front apertures 526a and 526b of the display element 523a. In some other implementations, each display element 523 can include a different number of front apertures. For example, each display element 523 can include one aperture, three apertures, or four apertures. To enhance the reflectance of the mirror display 520d, the front apertures 526 can be designed to occupy a relatively small portion of the total area of the image-rendering region. The ratio of the total area of the apertures to the total area of the image-rendering region of the mirror display 520d can be referred to as the aperture ratio. In general, decreasing the aperture ratio leads to increased reflectance of the mirror display 520d, but also tends to decrease the total light throughput for the mirror display 520d. However, in some implementations, the mirror display 520d can be implemented using MEMS shutter-based light modulators similar to those discussed above in connection with FIGS. 3A, 3B, 4A, and 4B. This type of display device can have a significantly higher light efficiency than display devices that use different technologies, such as liquid crystal displays. Therefore, in some implementations, the aperture ratio of the mirror display 520d can be decreased in order to achieve a high reflectance for the mirror display 520d, while still maintaining a relatively high brightness level. For example, the aperture ratio of the mirror display 520d can be less than about 50%, less than about 40%, less than about 30%, less than about 25%, less than about 20%, or less than about 10%. As discussed above, the mirror display 520d can include a front-facing reflective surface through which the apertures 526 are formed. Due to the relatively small aperture ratio, the reflective front layer of the mirror display 520d occupies a relatively large amount of the total surface area of the image-rendering region. Therefore, the mirror display 520d appears substantially reflective when the mirror display 520d is powered off or is otherwise not being used to form images. In some other implementations, the aperture ratio of the mirror display 520d can be greater than about 50%.

To further enhance the reflectance of the mirror display 520d, in some implementations, a front-facing surface of the shutters positioned behind the front reflective layer can be formed from a reflective material, as discussed above, and the shutters can be moved into their respective closed positions when the mirror display 520d is not being used to form images. Alternatively, a backlight of the mirror display 520d can include a front-facing reflective layer, and the shutters can be moved into their respective open positions when the mirror display 520d is not being used to form images.

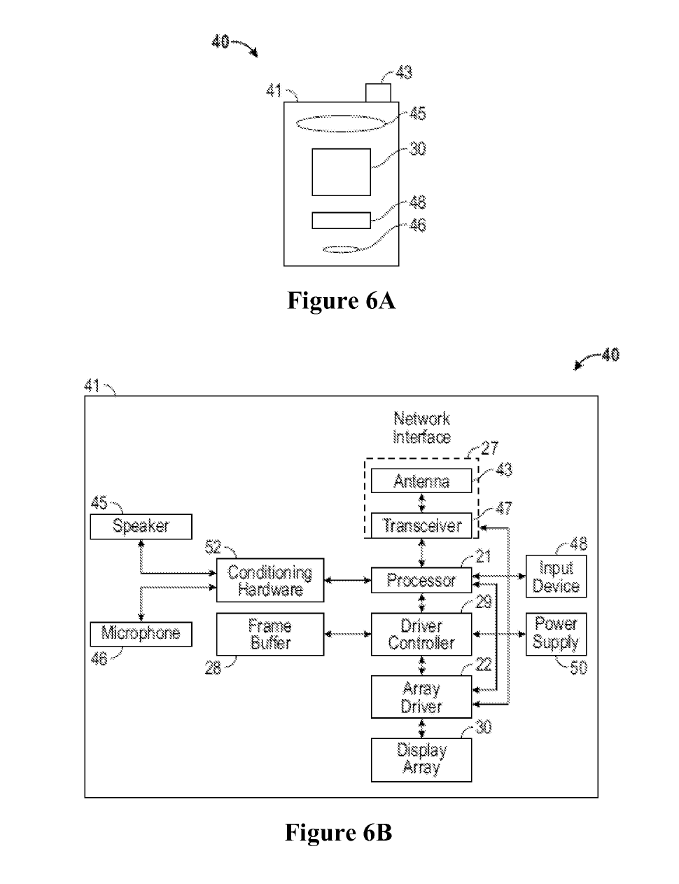

FIGS. 6A and 6B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 6B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 6A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A mirror display comprising:
a first transparent substrate;
a backlight on a first side of the first transparent substrate;
a second transparent substrate on a second side of the first transparent substrate:
a plurality of display elements within an image-rendering region between the first transparent substrate and the second transparent substrate;
a first light-blocking layer on a surface of the second transparent substrate nearest to the backlight, wherein the first light-blocking layer has a reflectance of at least about 50%; and
a plurality of apertures formed through the first light-blocking layer, each aperture corresponding to a respective one of the plurality of display elements, wherein the total area of the apertures accounts for less than about 50% of the area of the image-rendering region.

2. The mirror display of claim 1, wherein a surface of each display element farthest from the backlight has a reflectance of at least about 50%.

3. The mirror display of claim 2, wherein each display element is configured to be in a closed position when the mirror display is powered off.

4. The mirror display of claim 2, further comprising a controller configured to drive each display element into a closed position when the mirror display is powered off.

5. The mirror display of claim 1, wherein a surface of each display element farthest from the backlight is light absorbing.

6. The mirror display of claim 5, further comprising a controller configured to drive each display element into an open position when the mirror display is powered off.

7. The mirror display of claim 1, wherein the backlight includes a layer of reflective material configured to reflect light towards the second transparent substrate on a surface of the backlight farthest from the first transparent substrate.

8. The mirror display of claim 1, wherein the total area of the apertures accounts for less than about 25% of the area of the image-rendering region.

9. The mirror display of claim 1, wherein the first light-blocking layer comprises a dielectric mirror.

10. The mirror display of claim 1, further comprising a second light-blocking layer on a surface of the first transparent substrate on the second side of the first transparent substrate, wherein the second light-blocking layer is light absorbing.

11. The mirror display of claim 1, wherein at least one of a side mirror and a rear view mirror of an automobile includes the mirror display.

12. The mirror display of claim 1, wherein a wall mirror includes the mirror display.

13. The mirror display of claim 1, wherein the plurality of display elements comprises microelectromechanical systems (MEMS) shutter-based display elements.

14. The mirror display of claim 1, further comprising a second light-blocking layer on the surface of the second transparent substrate nearest to the backlight, wherein the second light-blocking layer is closer to the backlight than the first light-blocking layer.

15. The mirror display of claim 1, further comprising:
a processor capable of communicating with the mirror display, the processor being capable of processing image data; and
a memory device capable of communicating with the processor.

16. The mirror display of claim 15, further comprising:
a driver circuit capable of sending at least one signal to the mirror display; and
a controller capable of sending at least a portion of the image data to the driver circuit.

17. The mirror display of claim 15, further comprising:
an image source module capable of sending the image data to the processor, wherein the image source module includes at least one of a receiver, transceiver, and transmitter; and
an input device capable of receiving input data and communicating the input data to the processor.

18. A mirror display comprising:
a first transparent substrate;
a light emitting means on a first side of the first transparent substrate;
a second transparent substrate on a second side of the first transparent substrate, wherein the second side of the first transparent substrate is opposite the first side of the first transparent substrate;
a plurality of light modulating means within an image-rendering region between the first transparent substrate and the second transparent substrate;
a light-blocking means on a surface of the second transparent substrate nearest to the light emitting means, wherein the light-blocking means has a reflectance of at least about 50%; and
a plurality of apertures formed through the light-blocking means, each aperture corresponding to a respective one of the plurality of light modulating means, wherein the total area of the apertures accounts for less than about 50% of the area of the image-rendering region.

19. The mirror display of claim 18, wherein a surface of the light modulating means farthest from the light emitting means has a reflectance of at least about 50%.

20. The mirror display of claim 18, wherein a surface of each light modulating means farthest from the light emitting means is light absorbing.

21. The mirror display of claim 18, wherein the total area of the apertures accounts for less than about 25% of the area of the image-rendering region.

22. An apparatus comprising:
a mirror having an electrically active region including:
a first transparent substrate;
a backlight on a first side of the first transparent substrate;
a second transparent substrate on a second side of the first transparent substrate;
a plurality of shutter-based display elements between the first transparent substrate and the second transparent substrate;
a light-blocking layer on a surface of the second transparent substrate nearest to the backlight, wherein the light-blocking layer is substantially reflective; and
a plurality of apertures formed through the light-blocking layer, each aperture corresponding to a respective one of the plurality of display elements, wherein the total area of the apertures accounts for less than about 50% of the area of the electrically active region; and
a controller capable of driving the plurality of display elements into respective open and closed positions corresponding to image data.

23. The apparatus of claim 22, wherein a surface of each display element farthest from the backlight has a reflectance of at least about 50%.

24. The apparatus of claim 23, wherein each display element is configured to be in a closed position when the mirror display is powered off.

25. The apparatus of claim 23, wherein the controller is configured to drive each display element into a closed position when the mirror display is powered off.

26. The apparatus of claim 22, wherein a surface of each display element farthest from the backlight is light absorbing.

27. The apparatus of claim 26, wherein the controller is configured to drive each display element into an open position when the mirror display is powered off.

28. The apparatus of claim 22, wherein the backlight includes a layer of reflective material configured to reflect light towards the second transparent substrate on a surface of the backlight farthest from the first transparent substrate.

29. The apparatus of claim 22, wherein the total area of the apertures accounts for less than about 25% of the area of the electrically active region.

30. The apparatus of claim 22, wherein at least one of a side mirror and a rear view mirror of an automobile includes the apparatus.
